(19) United States
(12) Patent Application Publication
(10) Pub. No.: US 2023/0237230 A1
(43) Pub. Date: Jul. 27, 2023

(54) FAST FPGA COMPILATION FROM SOFTWARE FLOWS THROUGH PARTIAL RECONFIGURATION AND HARDENED NETWORK-ON-CHIP

(71) Applicant: Intel Corporation, Santa Clara, CA (US)

(72) Inventors: Michael Kinsner, Halifax (CA); Byron Sinclair, Toronto (CA); Deshanand P. Singh, Toronto (CA); Scott Jeremy Weber, Piedmont, CA (US); Anandh Venkateswaran, Santa Clara, CA (US); Mahesh A. Iyer, Fremont, CA (US)

(21) Appl. No.: 18/191,789

(22) Filed: Mar. 28, 2023

(51) Int. Cl. G06F 30/343; G06F 30/347

(52) U.S. Cl. CPC G06F 30/343; G06F 30/347; G06F 2119/12

(57) ABSTRACT

Systems or methods of the present disclosure may provide a library including multiple personas that may be pre-generated by a manufacturer and/or custom generated by a designer that may be used to implement a design onto an integrated circuit device. The design may be decomposed into one or more personas to be implemented as coarse-grained operations on the integrated circuit device, thereby decreasing compilation time experienced by the designer. The personas may be loaded into one or more regions of the integrated circuit device to realize the design. That is, the design may be realized by one persona may be implemented across multiple regions, one region may be configured by multiple personas, one persona configuring one region, or any combination thereof. Additionally or alternatively, the integrated circuit device may include networks-on-chip to improve data routing between the regions.

### BACKGROUND

The present disclosure relates generally to programmable logic devices. More particularly, the present disclosure relates to reducing compilation time for programmable logic devices, such as high-capacity field programmable gate arrays (FPGAs).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Programmable logic devices, a class of integrated circuits, may be programmed to perform a wide variety of operations. In certain instances, programming and compiling the programmable logic device with a high level design (HLD) may take long periods of time, such as over multiple hours or days. For example, the programmable logic devices may be fine-grained to compile register transfer level (RTL) based designs. The design may be decomposed into millions of primitives to be implemented onto the fine-grained programmable device, thereby causing a relatively long compile time (e.g., hours or days). The long compilation time may hinder market traction. For example, the long compilation time may increase both development cost and development time, thereby reducing adoption of programmable logic devices by users. Indeed, compilation time for programmable logic devices may be computationally intensive, resource intensive, and cost intensive due to the fine-grained nature of the programmable logic device.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of programmable fabric of the integrated circuit device of FIG. 1, in accordance with an embodiment of the present disclosure;

FIG. 4 is a block diagram of programmable fabric of the integrated circuit device of FIG. 1 implementing a design using partial reconfiguration (PR) regions, in accordance with an embodiment of the present disclosure;

FIG. 5 is a block diagram of programmable fabric of the integrated circuit device of FIG. 1 implementing a design using PR regions and a network-on-chip, in accordance with an embodiment of the present disclosure;

FIG. 6 is a block diagram of programmable fabric of the integrated circuit device of FIG. 1 implementing a design using PR regions and a network-on-chip, in accordance with an embodiment of the present disclosure;

FIG. 7 is a flowchart of a method for implementing a design onto the integrated circuit device of FIG. 1 using personas from a library, in accordance with an embodiment of the present disclosure;

FIG. 8 is a block diagram of a library with one or more personas for implementing a design onto the programmable fabric of the integrated circuit device of FIG. 1, in accordance with an embodiment of the present disclosure;

FIG. 9 is a flowchart of a method for configuring the programmable fabric of the integrated circuit device of FIG. 1 using one or more personas from a library, in accordance with an embodiment of the present disclosure; and

FIG. 10 is a block diagram of a data processing system including the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure describes systems and techniques related to implementing a design using coarse-grained operations onto integrated circuitry, such as high-capacity field programmable gate arrays (FPGAs), to decrease compilation time. In particular, the embodiments described herein are directed to using an array of partial reconfiguration (PR) regions for implementing one or more personas to reduce compilation time. For example, programmable logic devices, a class of integrated circuit devices, may be programmable to realize different high level designs (HLD). To decrease compilation time (e.g., from code to hardware execution), coarse-grained operations may be implemented rather than fine-grained operations.

Prior to compilation of a design from a designer, one or more personas may be generated, compiled, and stored in a library. The personas may include constant values, operators, commonly used operations, commonly used functionalities, and the like. The personas may be pre-compiled based on a location, an operation, a data type, and the like. The personas may then be stored in the library. Additionally, a designer may add one or more custom personas to the library. For example, the designer may use specialized (e.g., non-standardized) operations and generate a custom persona based on the specialized operations for the library.

Design software may receive a design for implementing onto the integrated circuit. The design software may include a tool for decomposing the design into one or more personas and for determining a location for compiling each persona on the integrated circuit device. To this end, the tool may decompose the design into a data flow (e.g., data flow graph) of coarse-grained operations and map the data flow to the personas stored in the library. The tool may also determine a location for each persona and/or routing mechanisms between the personas. To this end, the integrated circuit device may include an array of PR regions that may be reconfigured based on the persona (e.g., bit stream). In certain instances, one PR region may be configured by one persona. In other instances, one PR region may be configured by multiple personas to improve implementation efficiency. Still in other instances, multiple PR regions may be configured by one persona, such as a complex operation or a complex functionality. By configuring the PR regions with pre-compiled personas, compilation time experienced by the designer may decrease since the personas may represent coarse-grained operations. For example, the compilation time using pre-compilation of at least portions of the personas in the PR regions may be a few seconds to a few minutes or at least shorter than compilation not using pre-compilation of at least portions of the personas. Further, the integrated circuit device may include network-on-chips (NOCs) to improve data transport between the PR regions and enable spatial decoupling of logic resources without substantially increasing compilation time. Indeed, reducing compilation time may increase adoption of programmable logic devices by reducing time, costs, and resources used to bring the designs and/or devices to market.

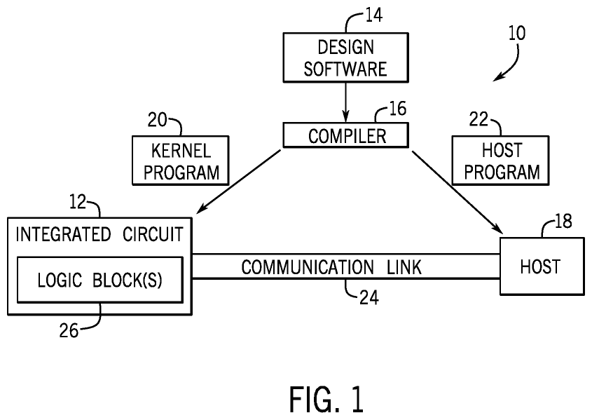

With the foregoing in mind, FIG. 1 illustrates a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program, which may enable the designer to more efficiently and easily provide programming instructions to configure a set of programmable logic cells for the integrated circuit device 12 without specific knowledge of low-level hardware description languages (e.g., Verilog or VHDL). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of a logic block 26 on the integrated circuit device 12. The logic block 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. In another example, the design software 14 may be used to route first data to a portion of the integrated circuit device 12 and route second data, power, and clock signals to a second portion of the integrated circuit device 12. Further, in some embodiments, the system 10 may be implemented without a separate host program 22. Moreover, in some embodiments, the techniques described herein may be implemented in circuitry as a non-programmable circuit design. Thus, embodiments described herein are intended to be illustrative and not limiting.

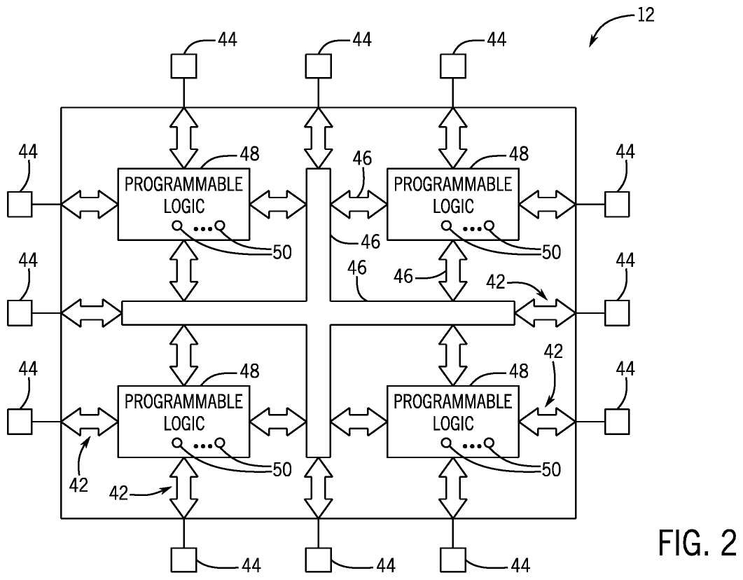

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation ASIC and/or application-specific standard product). The integrated circuit device 12 may have input/output circuitry 42 for driving signals off device and for receiving signals from other devices via input/output pins 44. Interconnection resources 46, such as global and local vertical and horizontal conductive lines and buses, and/or configuration resources (e.g., hardwired couplings, logical couplings not implemented by user logic), may be used to route signals on integrated circuit device 12. Additionally, interconnection resources 46 may include fixed interconnects (conductive lines) and programmable interconnects (i.e., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program programmable elements 50. In general, programmable elements 50 may be based on any suitable programmable technology, such as fuses, antifuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. For instance, in some embodiments, the output signals may be applied to the gates of metal-oxide-semiconductor (MOS) transistors within the programmable logic 48.

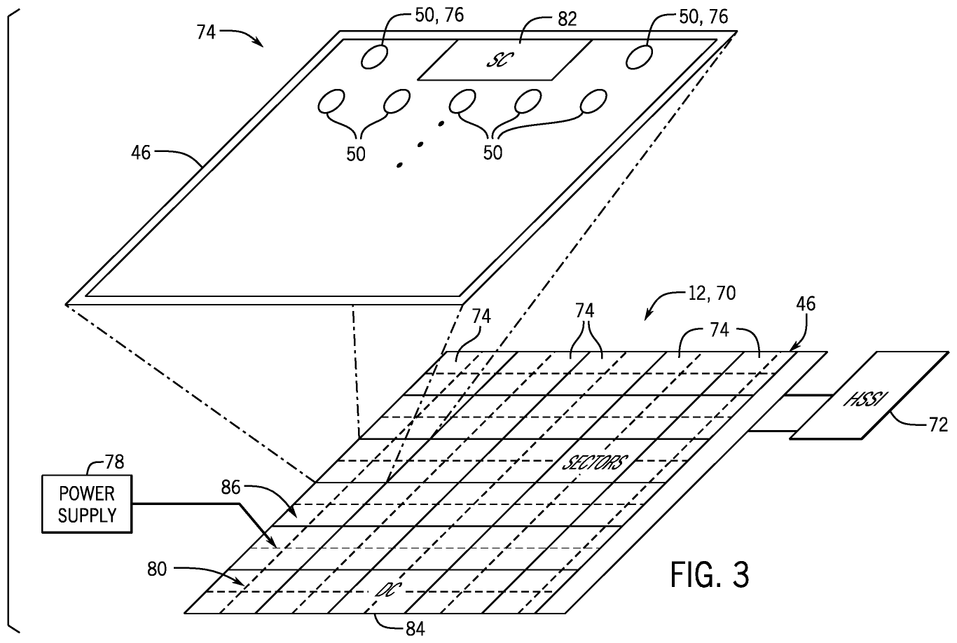

The integrated circuit device 12 may include any programmable logic device such as a field programmable gate array (FPGA) 70, as shown in FIG. 3. For the purposes of this example, the FPGA 70 is referred to as a FPGA, though it should be understood that the device may be any suitable type of programmable logic device (e.g., an application-specific integrated circuit and/or application-specific standard product). In one example, the FPGA 70 is a sectorized FPGA of the type described in U.S. Patent Publication No. 2016/0049941, “Programmable Circuit Having Multiple Sectors,” which is incorporated by reference in its entirety for all purposes. The FPGA 70 may be formed on a single plane. Additionally or alternatively, the FPGA 70 may be a three-dimensional FPGA having a base die and a fabric die of the type described in U.S. Pat. No. 10,833,679, “Multi-Purpose Interface for Configuration Data and User Fabric Data,” which is incorporated by reference in its entirety for all purposes.

In the example of FIG. 3, the FPGA 70 may include transceiver 72 that may include and/or use input/output circuitry, such as input/output circuitry 42 in FIG. 2, for driving signals off the FPGA 70 and for receiving signals from other devices. Interconnection resources 46 may be used to route signals, such as clock or data signals, through the FPGA 70. The FPGA 70 is sectorized, meaning that programmable logic resources may be distributed through a number of discrete programmable logic sectors 74. Programmable logic sectors 74 may include a number of programmable logic elements 50 having operations defined by configuration memory 76 (e.g., CRAM). A power supply 78 may provide a source of voltage (e.g., supply voltage) and current to a power distribution network (PDN) 80 that distributes electrical power to the various components of the FPGA 70. Operating the circuitry of the FPGA 70 causes power to be drawn from the power distribution network 80.

There may be any suitable number of programmable logic sectors 74 on the FPGA 70. Indeed, while 29 programmable logic sectors 74 are shown here, it should be appreciated that more or fewer may appear in an actual implementation (e.g., in some cases, on the order of 50, 100, 500, 1000, 5000, 10,000, 50,000 or 100,000 sectors or more). Programmable logic sectors 74 may include a sector controller (SC) 82 that controls operation of the programmable logic sector 74. Sector controllers 82 may be in communication with a device controller (DC) 84.

Sector controllers 82 may accept commands and data from the device controller 84 and may read data from and write data into its configuration memory 76 based on control signals from the device controller 84. In addition to these operations, the sector controller 82 may be augmented with numerous additional capabilities. For example, such capabilities may include locally sequencing reads and writes to implement error detection and correction on the configuration memory 76 and sequencing test control signals to effect various test modes.

The sector controllers 82 and the device controller 84 may be implemented as state machines and/or processors. For example, operations of the sector controllers 82 or the device controller 84 may be implemented as a separate routine in a memory containing a control program. This control program memory may be fixed in a read-only memory (ROM) or stored in a writable memory, such as random-access memory (RAM). The ROM may have a size larger than would be used to store only one copy of each routine. This may allow routines to have multiple variants depending on “modes” the local controller may be placed into. When the control program memory is implemented as RAM, the RAM may be written with new routines to implement new operations and functionality into the programmable logic sectors 74. This may provide usable extensibility in an efficient and easily understood way. This may be useful because new commands could bring about large amounts of local activity within the sector at the expense of only a small amount of communication between the device controller 84 and the sector controllers 82.

Sector controllers 82 thus may communicate with the device controller 84, which may coordinate the operations of the sector controllers 82 and convey commands initiated from outside the FPGA 70. To support this communication, the interconnection resources 46 may act as a network between the device controller 84 and sector controllers 82. The interconnection resources 46 may support a wide variety of signals between the device controller 84 and sector controllers 82. In one example, these signals may be transmitted as communication packets.

The use of configuration memory 76 based on RAM technology as described herein is intended to be only one example. Moreover, configuration memory 76 may be distributed (e.g., as RAM cells) throughout the various programmable logic sectors 74 of the FPGA 70. The configuration memory 76 may provide a corresponding static control output signal that controls the state of an associated programmable logic element 50 or programmable component of the interconnection resources 46. The output signals of the configuration memory 76 may be applied to the gates of metal-oxide-semiconductor (MOS) transistors that control the states of the programmable logic elements 50 or programmable components of the interconnection resources 46.

The programmable elements 50 of the FPGA 40 may also include some signal metals (e.g., communication wires) to transfer a signal. In an embodiment, the programmable logic sectors 74 may be provided in the form of vertical routing channels (e.g., interconnects formed along a y-axis of the FPGA 70) and horizontal routing channels (e.g., interconnects formed along an x-axis of the FPGA 70), and each routing channel may include at least one track to route at least one communication wire. If desired, communication wires may be shorter than the entire length of the routing channel. That is, the communication wire may be shorter than the first die area or the second die area. A length L wire may span L routing channels. As such, a length of four wires in a horizontal routing channel may be referred to as “H4” wires, whereas a length of four wires in a vertical routing channel may be referred to as “V4” wires.

As discussed above, some embodiments of the programmable logic fabric may be configured using indirect configuration techniques. For example, an external host device may communicate configuration data packets to configuration management hardware of the FPGA 70. The data packets may be communicated internally using data paths and specific firmware, which are generally customized for communicating the configuration data packets and may be based on particular host device drivers (e.g., for compatibility). Customization may further be associated with specific device tape outs, often resulting in high costs for the specific tape outs and/or reduced scalability of the FPGA 70.

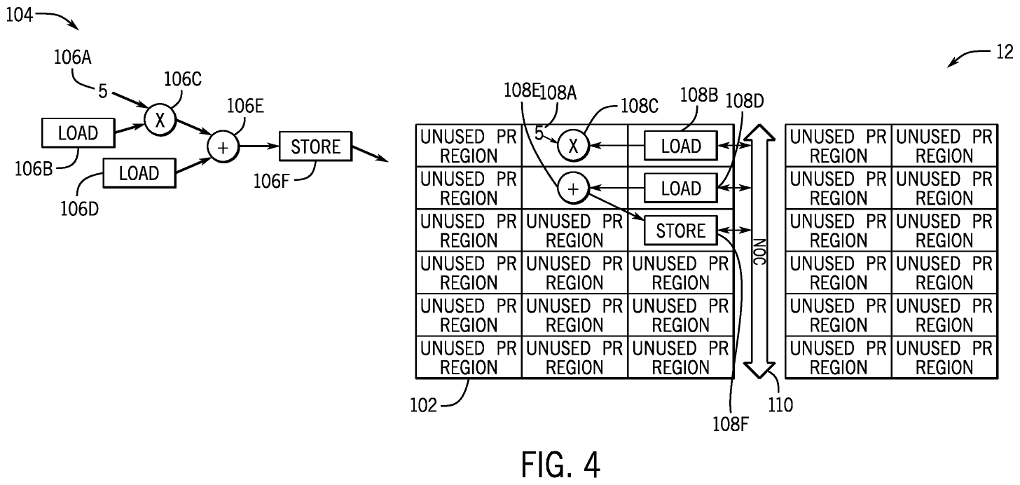

FIG. 4 is a block diagram of programmable fabric of the integrated circuit device 12 implementing a design using PR regions 102. As discussed herein, a designer may implement high-level designs onto the integrated circuit device 12 using the design software 14. For example, the designer may use the design software 14 to specify a high-level program and/or a high level design to be implemented on the integrated circuit device 12. The design may be in high-level programming language, such as an array language, Python, C#, C++, and the like. The design may also include configuration of circuitry and/or other logic elements to implement arithmetic operations, such as addition, subtraction, multiplication, and so on. Additionally or alternatively, the design may map a workload to one or more routing resources based on a timing, a wire usage, a logic usage, and/or a routability.

In certain instances, the design software 14 may include a tool to convert the high-level design into a lower-level description. For example, the tool (e.g., compiler 16, LLVM IR) may decompose the design into a compiler data flow graph 104. The tool may decompose the design by defining a bounded set of primitive operators, define a standard data type and width, define a memory access mode and/or memory models, control flow graphs, one or more personas, and the like. That is, high level bounding may be used to generate the compiler data flow graph 104 based on the design.

The compiler data flow graph 104 may include any suitable number of graph nodes 106 (individually referred to as graph nodes 106A, 106B, 106C, 106D, 106E, and 106F) to realize the design on the integrated circuit device 12. For example, the graph nodes 106 may include constant values, data types, operators, functionality blocks, operational blocks, and the like. For example, the data flow graph 104 may be an operation, such as five multiplied by data loaded from the memory, added to additional data loaded from the memory, and the sum may be stored back to the memory. To this end, the data flow graph 104 may include a first graph node 106A including a constant value, a second graph node 106B including a functionality, a third graph node 106C including an operator, a fourth graph node 106D including a functionality, a fifth graph node 106E including an operator, and a sixth graph node 106F including a functionality. The first graph node 106A may include the number five or any other suitable constant number, the second graph node 106B and fourth graph nodes 106D may include the functionality of loading data from the memory, the sixth graph node 106F may include the functionality of storing the data to the memory. The third graph node 106C may include a multiplier and the fifth graph node 106E may include an adder.

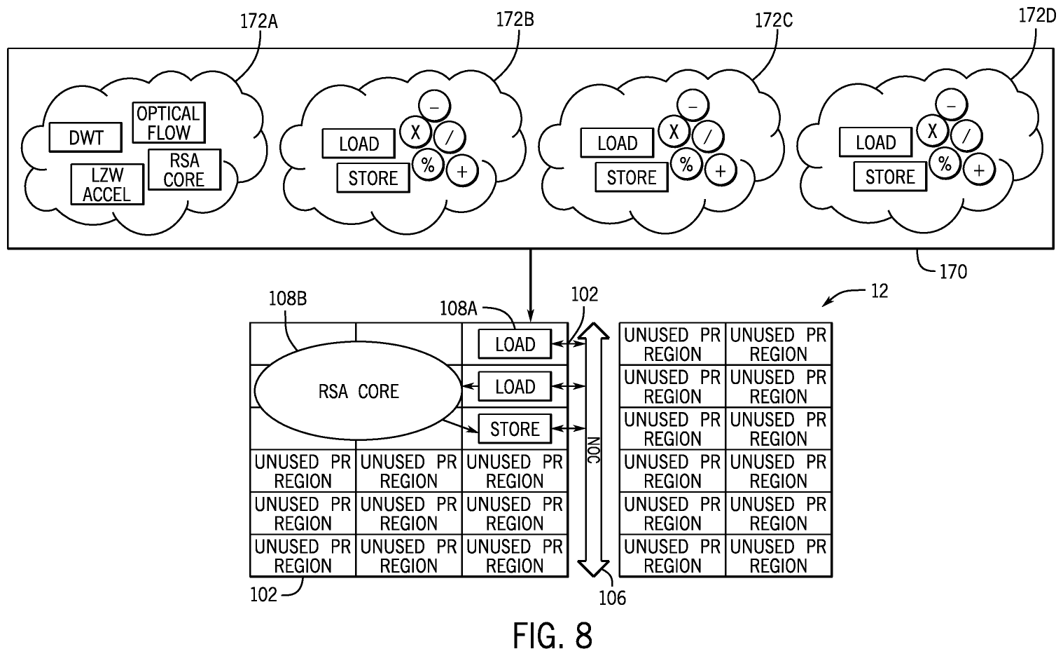

Each of the graph nodes 106 may be mapped to a persona 108 (individually referred to as 108A, 108B, 108C, 108D, 108E, and 108F). As further described with respect to FIG. 8, the personas 108 may be coarse-grained operations and stored in a library. For example, the persona 108 may be a pre-compiled operation, functionality, operator, number, data type, constant value, and the like. As illustrated, the first graph node 106A may be mapped to a first persona 108A, the second graph node 106B may be mapped to a second persona 108B, a third graph node 106C may be mapped to a third persona 108C, and so on. For example, the first persona 108A may be a constant value, the second persona 108B may be a functionality, and the third persona 108C may be an operator. The personas 108 may be pre-compiled based on a location, a data type, an operation, and so on. In this way, the pre-compiled coarser-grained primitives may be implemented in the integrated circuit device 12.

The pre-compiled personas 108 may be loaded into the PR regions 102 to configure the integrated circuit device 12. As illustrated, the integrated circuit device 12 may include an array of PR regions 102. The PR regions 102 may include the sector 74, a portion of the sector 74, multiple sectors 74, and so on. Additionally or alternatively, the PR regions 102 may be a partition, a portion of the partition, multiple partitions, and so on. Although the illustrated PR regions 102 appear uniform in shape and size, the PR regions 102 may be any suitable shape or size with the same or different sizes. The PR regions 102 may be communicatively coupled through boundary interfaces, global networks with switches, communication wires, trace lines/metal interconnect layers, and the like. In certain instances, one persona 108 may be loaded into one PR region 102. For example, the second persona 108B, the fourth persona 108D, the fifth persona 108E, and the sixth persona 108F may each be loaded into different PR regions 102. To this end, the PR region 102 may receive a bit stream of data to load the persona 108. In other instances, one or more personas 108 may be loaded into one PR region 102. For example, personas 108 with constant values and/or operators may not use all of the resources supported by the PR region 102. To improve implementation efficiency, multiple personas 108 may be loaded into one PR region 102, or clustered in the PR region 102. For example, as illustrated, the first persona 108A and the third persona 108C may be clustered in one PR region 102. In other instances, one persona 108 may be loaded into multiple PR regions 102. As further described with respect to FIG. 6, one persona 108 including a complex operation and/or a complex functionality may be loaded into multiple PR regions 102. The personas 108 may be loaded to target spatial implementations, such as unrolling and dependence distance minimization. For example, tools, such as Versatile Packing, Placement and Routing (VPR) with simulated annealing, may minimize wire lengths for coarse-grained partial reconfiguration of the integrated circuit device 12.

The PR regions 102 may be timing closed prior to compiling the integrated circuit device 12. For example, each PR region 102 may include a maximum frequency (Fmax) and timing that may be received from an outer register in a partition outside the PR region 102. The integrated circuit device 12 may include a static, timing locked partition with logic that may be separate from the design, such as memory controllers, PR controllers, and transceivers. For example, timing analysis of each PR region 102 may be performed to determine a longest path between a first PR region 102 implementing a first persona 108 and a second PR region 102 implementing a different persona 108. In this way, a longest path between each of the PR regions 102 may be determined and clock phase-locked loops (PLLs) may be set to a worst case possible timing. In another example, the clock PLLs may be set to a frequency of a longest critical path between the PR regions 102. The frequency may be determined based on connectivity between the PR regions 102. The coarse-grained partial reconfiguration may optionally model the timing paths between the outermost registers of PR regions 102 to improve placements of the timing paths for an operating frequency. In this way, loading of the personas 108 into the PR regions 102 may be timing closed.

In certain instances, the integrated circuit device 12 may include a network-on-chip (NOC) 110 to improve implementation efficiency and flexibility of placement locations. For example, the NOC 110 may be a hardened NOC used for data transport. The personas 108 may be placed adjacent to the NOC 110 to improve data consumption and/or production logic placement. The personas 108 may transmit and receive data to and from the NOC 110 using one or more interface bridges. As illustrated, memory access units (e.g., the second persona 108B, the fifth persona 108E, the sixth persona 108F) may be located in fixed PR regions 102 that are adjacent to or coupled to the NOC 110. As such, loading and storing of data to and from the memory may be improved.

Although the discussion is based on one design and one data flow graph 104, multiple data flow graphs 104 (e.g., kernels) may be created and implemented onto the integrated circuit device 12. For example, multiple designers may independently create a respective design that may be decomposed into respective data flow graphs 104 for configuring the same integrated circuit device 12. In another example, one designer may create multiple designs for configuring the integrated circuit device 12. With the NOC 110 and the PR regions 102, one kernel may be implemented while other designers may be executing additional kernels for multi-tenancy or performance optimization of task graph scheduling or execution. In another example, integrated circuit device 12 may concurrently support multiple kernels, partitioning of different PR regions, temporal PR reconfigurations, and so on.

In certain instances, the PR regions 102 implementing one kernel may be reconfigured while one or more additional kernels is executing on the integrated circuit device 12. For example, coarse-grained function units in the PR framework may be decoupled at one or more cut lines by the nature of the coarse-grained assembly flow. Control and buffering inserted at the cut lines by partial reconfiguration or earlier compilations may allow arbitrarily sized kernels with phased execution to fit on the integrated circuit device 12, even if all elements of the kernel may not fit at the same time. In another example, the design may be too large to be implemented in the available PR regions 102 of the integrated circuit device 12. As such, a first portion of the design (e.g., at a cut line) may be implemented and executed on the integrated circuit device 12, then a second portion of the design may be implemented and executed. After a partial reconfiguration, the second portion of the design may be implemented in some of the same PR regions 102 that implemented the first portion of the design before the partial reconfiguration. Additionally or alternatively, arbitrarily sized code may be mapped to one or more personas 108 and implemented on the integrated circuit device 12 without user intervention. As such, the integrated circuit device 12 may be dynamically reconfigured.

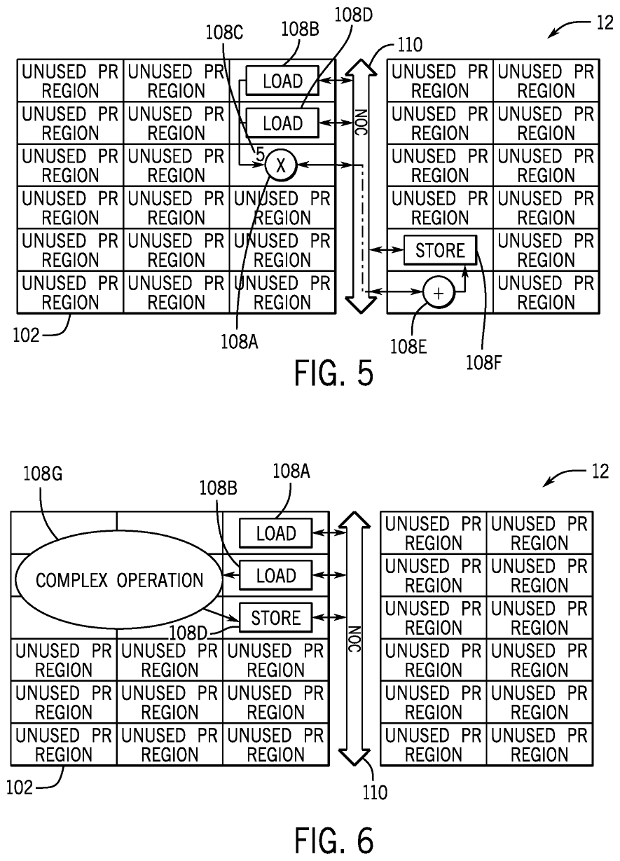

FIG. 5 is a block diagram of programmable fabric of the integrated circuit device 12 implementing a design using PR regions 102 and a NOC 110 in an alternative arrangement than that used in FIG. 4. In certain instances, the personas 108 may be loaded into PR regions 102 adjacent to the NOC 110 to improve data flow to and from a memory without being constrained to physically adjacent PR regions 102. In other words, the PR regions 102 may be adjacent to each other to improve data flow between the PR regions 102 in some embodiments while being not adjacent and using the NOC 110 in other embodiments. In certain instances, the NOC 110 may be used as a connectivity mechanism between different parts of the PR regions 102 and/or the data flow graph 104. For example, a first portion of the data flow graph 104 may be implemented in a first portion (e.g., alongside a left side of the NOC 110) of the integrated circuit device 12 and a second portion of the data flow graph 104 may be implemented in a second portion (e.g., alongside a right side of the NOC 110) of the integrated circuit device 12. As illustrated, the personas 108 may be spatially located in different areas of the integrated circuit device 12 and connected by the NOC 110. The first persona 108A, the second persona 108B, the third persona 108C, and the fourth persona 108D may be located in the first portion of the integrated circuit device 12, while the fifth persona 108E and the sixth persona 108F may be located in the second portion of the integrated circuit device 12. As such, the NOC 110 may support communication between the first persona 108A, the second persona 108B, the third persona 108C, the fourth persona 108D, the fifth persona 108E, and the sixth persona 108F or any sub-combination thereof. In this way, the personas 108 may be physically distributed through various portions of the integrated circuit device 12. Indeed, each of the personas 108 may be located in a PR region 102 that may be adjacent the NOC 110 to improve implementation efficiency. However, the personas 108 may be located in any PR region 102 within the integrated circuit device 12 and communicate by routing between the PR regions 102 and/or the NOC 110. That is, the NOC 110 may be used for data transportation.

FIG. 6 is a block diagram of programmable fabric of the integrated circuit device 12 implementing a design using the PR regions 102 and a NOC 110. In certain instances, the design may include complex operations, such as trigonometry, machine learning, artificial intelligence, and so on that may consume more processing resources than would be available in a single PR region 102. The complex operation may be implemented by multiple lookup tables, memory resources, data structures, operations, and the like. The complex operation may be mapped to a persona 108 (e.g., persona 108G) that may be implemented into the PR region 102 of the integrated circuit device 12.

In certain instances, the PR region 102 may not include enough physical resources to support the persona 108G including the complex operation. To this end, the persona 108G may be implemented by multiple PR regions 102. For example, multiple PR regions 102 may be treated as a sub-graph of unit-sized PR regions 102. As illustrated, the persona 108G may be implemented across six PR regions 102. However, in other instances, the persona 108G may be implemented across any suitable number of PR regions 102, such as 2, 3, 4, 5, 8, 10, 20, or more PR regions 102. In another example, the complex operation may be divided into multiple smaller operations and each smaller operation may be mapped to a respective persona 108. Each persona 108 may be implemented into one PR region 102 as a smaller operation and routing between the PR regions 102 may form the complex operation.

In other instances, at least some of the PR regions 102 may be large in comparison to at least some personas 108. For example, the persona 108 may include an operator (e.g., HL language operator), such as an adder, multiplier, and so on. Since the PR region 102 may be large in comparison to the persona 108, implementing one persona 108 may result in a majority of the PR region 102 remaining unused. As such and as previously noted, multiple personas 108 may be clustered within the PR region 102, thereby improving efficiency of implementation. As discussed with respect to FIGS. 4 and 5, two personas 108 may be clustered into one PR region 102. In another example, three or more personas 108 associated with different operators and/or constant values may be clustered within one PR region 102. The personas 108 may be clustered in the PR regions 102 with static or runtime-configurable connectivity between the personas 108. In other words, the PR regions 102 may include connections, such as connection wires, tracing/metals, and the like to support connectivity between the clustered personas 108. The clustered personas 108 may be part of the placement route for additional personas 108 to realize the design.

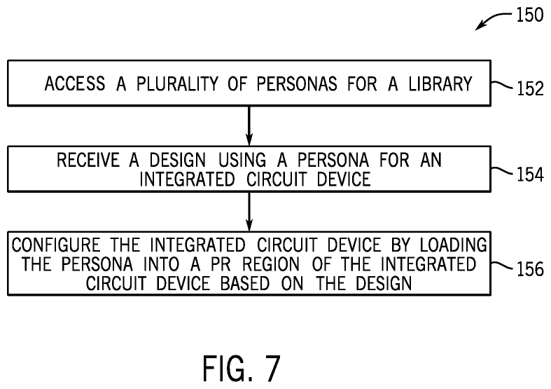

FIG. 7 is a flowchart of a method 150 for implementing a design into the integrated circuit device 12 using a library of personas. A designer may develop a design for the integrated circuit device 12. For example, the designer may use the design software 14 to develop the design. The design may include a functionality, an operation, a mathematical operation, and the like to be implemented onto the integrated circuit device 12. The software may decompose the design into one or more pre-compiled personas 108 and implement coarse-grained operations onto the integrated circuit device 12, thereby reducing compilation time.

With the foregoing in mind, at block 152, a plurality of personas 108 for a library may be accessed. Accessing the library may include generating the personas 108 and/or accessing entries in storage that detail the personas 108. The library may include personas 108 generated by, for, and/or using the design software 14 or may be received from others (e.g., other user designs from other users). For example, the library may include multiple personas 108 each for implementing an operation, a constant value, an operator, a functionality, and/or the like onto the integrated circuit device 12. The personas 108 may include general operations and/or operators that may be used in the design. To decrease compilation time, the personas 108 may be pre-compiled based on a location, a data type, an operation, and the like. For example, certain personas 108 may be pre-compiled based on a location and translation of the bit stream may be used to move (e.g., load) the persona 108 into other PR regions 102. As discussed above, certain the personas 108 may be pre-generated prior to shipping the integrated circuit device 12 to the designer. Additionally or alternatively, the designer may create one or more functions that may be specific to the designer that may be stored as a pre-compiled persona 108.

At block 154, a design using a persona 108 may be received. For example, the design software 14 may receive a design for implementing onto the integrated circuit device 12. The design may be bounded into a data flow graph 104 including one or more graph nodes 106. The graph nodes 106 may be mapped to one or more personas 108 stored in the library. In certain instances, a persona 108 may include a complex operation and/or functionality that may be divided into one or more smaller operations. The smaller operations may be included in their own separate personas 108 or may amassed into a single persona for a common operation

At block 156, the integrated circuit device 12 may be configured by loading the personas 108 into the PR regions 102 based on the design. For example, the PR regions 102 may be pre-compiled with the personas 108 and routing between the PR regions 102 may be used to implement the design, thereby reducing compilation time experienced by the designer. The personas 108 may be spatially located adjacent to a NOC 110 to improve routing of resources to each persona 108. For example, a first portion of the design may be clustered within a first portion of the integrated circuit device 12, a second portion of the design may be clustered within a second portion, and the NOC 110 may be used to facilitate data flow between the two portions. In another example, translation between the PR regions 102 may be used to load the persona 108 into a PR region 102 and routing between the PR regions 102 may be used to realize the design. Still in another example, the personas 108 may be loaded into PR regions 102 by a bit stream and used to partially reconfigure the integrated circuit device 12. As previously noted, this partial reconfiguration may be used to perform different objectives in the same PR region 102 in a sequential manner before and after a partial reconfiguration.

The method 150 includes various steps represented by blocks. Although the flow chart illustrates the steps in a certain sequence, it should be understood that the steps may be performed in any suitable order and certain steps may be carried out simultaneously, where appropriate. Further, certain steps or portions of the method 150 may be performed by separate systems or devices.

FIG. 8 is a block diagram of a library 170 with one or more sets of personas 172 (individually referred to as 172A, 172B, 172C, and 172D) for implementing the design. For example, the sets of personas 172 may be generated by the manufacturer, the designer, other designers, third parties, and/or any other suitable source. In certain instances, the sets of personas 172 may be generated by the manufacturer prior to shipping the integrated circuit device 12 and/or may be updated in the design software 14 after shipment. The sets of personas 172A may correspond to a bit width, a data type, an integer, programming language, and the like. For example, the set of personas 172B, 172C, and 172D may be pre-generated and may include int8 personas, int16 personas, int32 personas, int64 personas, fp8 personas, fp16 personas, fp32 personas, fp64 personas, and so on. Additionally or alternatively, the sets of personas 172 may be updated by the manufacturer or other designers and transmitted to the design software 14 to update the library 170. For example, the manufacturer may redesign a persona within the set of personas 172 to improve implementation efficiency or increase flexibility with additional options and transmit an indication of the redesigned persona 108A to the library 170 for storage. Indeed, some personas may be bundled and downloaded on demand in bundles (e.g., floating-point operators, etc.).

In some instances, the set of personas 172 may be generated by the designer (or other designers). For example, a set of custom generated personas 172A may include int19 personas, int35 personas, custom operators, custom functionalities, a Rivest-Shamir-Adleman (RSA) core, an optical flow accelerator, a Lempel-Ziv-Welch (LZW) accelerator, a discrete wavelet transformation (DWT) operation, an artificial intelligence (AI) accelerator, and the like. In certain instances, the custom generated persona 108B may be generated during decomposition of the design and/or may be manually saved by its designer. In some embodiments, the designer may choose to share with other designers. For instance, the share may be domain limited within a tenancy/customer environment or may be shared with other tenants or environments. The set of custom-generated personas 172A may be stored in the library 170 and used in subsequent compilations. In another instance, the designer may load a persona 108 from the set of custom generated personas 172A using the design software 14 prior to implementing the design.

Both the pre-generated personas 108A and the custom generated personas 108B may be implemented on the integrated circuit device 12. As illustrated, the integrated circuit device 12 may implement the pre-generated personas 108A including the operations of loading and/or storing data to and from the memory and the custom generated persona 108B including a Rivest-Shamir-Adleman (RSA) core used in ASIC and FPGA designs. The pre-generated personas and the custom personas may be pre-compiled so that implementation of the personas does not need to be compiled again thereby reducing a compilation time for the design by using the pre-compiled personas.

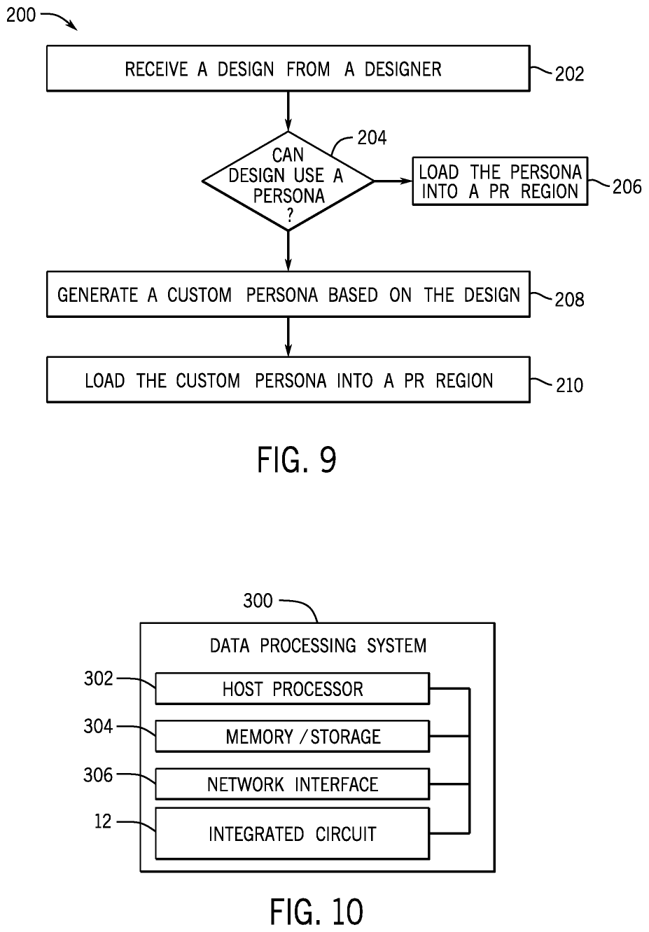

FIG. 9 is a flowchart of a method 200 for configuring the integrated circuit device 12 using one or more personas 108 from the library 170. The library 170 may include pre-generated personas 108A and custom generated personas 108B that have previously been compiled before the design using the personas 108 is compiled.

At block 202, the design may be received. For example, the designer may create the design using the design software 14. In another example, the designer may load the design into the design software 14. As previously noted, the design software 14 may decompose the design 100 into coarse-grained primitives.

At block 204, a determination if the design can use a persona 108 is made. For example, the design software 14 may determine whether the graph nodes 106 of the design may map to personas 108 and/or a set of personas 172 within the library 170. For instance, the design software 14 may compare the operations of the graph nodes 106 to the operations of the personas 108 to determine whether there is an appropriate mapping. If so, the design software 14 may map the graph node(s) 106 to the personas 108. In this way, the design software 14 may identify one or more personas 108 for configuring the PR regions 102 and implement the design using pre-compiled personas 108.

If the design may be implemented using the pre-compiled personas 108 in the library 170, then at block 206, the personas 108 may be loaded into the appropriate PR regions 102. For example, the design software 14 may identify one or more personas 108 that may be loaded into the PR regions 102 and determine a routing between the PR regions 102 to implement the design. Additionally or alternatively, the design software 14 may transmit a bit stream indicative of the persona 108 to configure the PR region 102. Additionally or alternatively, the design software 14 may translate the persona 108 from a first PR region 102 to a second PR region 102 via one or more translation flows. In some instances, the design software 14 may implement a first portion of the design over a first period of time within a first number of PR regions 102. To this end, the design software 14 may determine a cut line within the design based on the coarse-grained primitives. After the first period of time, the design software 14 may implement the second portion of the design over a second period of time within the first number of PR regions 102. In this way, the design software 14 may load the personas 108 into the PR regions 102 and partially reconfigure the integrated circuit device 12 to use at least some PR regions 102 for different functions at different points in time.

If the design may not be implemented using the personas 108, then at block 208, a custom persona may be generated. For example, the pre-generated personas may not include an operation, functionality, operator, and the like used in the design. In other words, the design software 14 may not map the design to a persona 108 within the library 170. As such, the design software 14 may generate a custom generated persona based on the design and/or the respective graph node 104. The design software 14 may also store the custom generated persona in the library 170. The newly generated persona is to be compiled during user compile time. However, once compiled, the compilation does not need to be redone if the custom persona is saved to the library 170 to be used in the future. In certain instances, the design software 14 may tag (e.g., name, label) the custom generated persona based on a constant value, an operation, an operator, a functionality, or so on. In other instances, the design software 14 may request user input to tag the custom generated persona.

At block 210, the custom generated persona may be loaded into a PR region 102. For example, the design software 14 may pre-compile the custom generated persona based on the data type, the location, the operation, and the like. In certain instances, the design software 14 may perform a translation flow to change a location of the custom generated persona. As such, the personas 108 may be pre-compiled as coarse-grained operations, thereby reducing compile time. The design software 14 may also determine routing between the PR regions 102 to implement the design.

The method 200 includes various steps represented by blocks. Although the flow chart illustrates the steps in a certain sequence, it should be understood that the steps may be performed in any suitable order and certain steps may be carried out simultaneously, where appropriate. Further, certain steps or portions of the method 200 may be performed by separate systems or devices.

Bearing the foregoing in mind, the integrated circuit device 12 may be a component included in a data processing system, such as a data processing system 300, shown in FIG. 10. The data processing system 300 may include the integrated circuit device 12 (e.g., a programmable logic device), a host processor 304 (e.g., a processor), memory and/or storage circuitry 306, and a network interface 308. The data processing system 300 may include more or fewer components (e.g., electronic display, user interface structures, application specific integrated circuits (ASICs)). Moreover, any of the circuit components depicted in FIG. 10 may include integrated circuits (e.g., integrated circuit device 12). The host processor 304 may include any of the foregoing processors that may manage a data processing request for the data processing system 300 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 306 may include random access memory (RAM), read-only memory (ROM), one or more hard drives, flash memory, or the like. The memory and/or storage circuitry 306 may hold data to be processed by the data processing system 300. In some cases, the memory and/or storage circuitry 306 may also store configuration programs (bitstreams) for programming the integrated circuit device 12. The network interface 308 may allow the data processing system 300 to communicate with other electronic devices. The data processing system 300 may include several different packages or may be contained within a single package on a single package substrate. For example, components of the data processing system 300 may be located on several different packages at one location (e.g., a data center) or multiple locations. For instance, components of the data processing system 300 may be located in separate geographic locations or areas, such as cities, states, or countries.

In one example, the data processing system 300 may be part of a data center that processes a variety of different requests. For instance, the data processing system 300 may receive a data processing request via the network interface 308 to perform encryption, decryption, machine learning, video processing, voice recognition, image recognition, data compression, database search ranking, bioinformatics, network security pattern identification, spatial navigation, digital signal processing, or some other specialized task.

The above discussion has been provided by way of example. Indeed, the embodiments of this disclosure may be susceptible to a variety of modifications and alternative forms. Indeed, many other suitable forms of high-capacity integrated circuits can be manufactured according to the techniques outlined above. For example, other high-capacity integrated circuit devices may include an array of PR regions 102 that may be configured with one or more personas 108. The personas 108 may be pre-compiled to reduce the compilation time experienced by the designer. In this way, the high-capacity integrated circuit may be reconfigured and/or configured using less time. Moreover, the high-capacity integrated circuit device may include networks-on-chip used for data transfer, thereby improving implementation efficiency of the design.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. A tangible, non-transitory, and computer-readable medium, storing instructions thereon, wherein the instructions, when executed, are to cause a processor to receive a design to be implemented onto a programmable fabric of an integrated circuit device, determine that the design is implementable using a persona from a library comprising a plurality of personas, compile the design, wherein the plurality of personas are compiled at a different time than the design, and transmit a bit stream to partially reconfigure the integrated circuit device using the persona, wherein the bit stream comprises data to configure a region of the integrated circuit device.

EXAMPLE EMBODIMENT 2. The tangible, non-transitory, and computer-readable medium of example embodiment 1, wherein the instructions, when executed, are to cause the processor to decompose the design into a compiler data flow graph comprising one or more graph nodes and map the one or more graph nodes to one or more personas of the plurality of personas.

EXAMPLE EMBODIMENT 3. The tangible, non-transitory, and computer-readable medium of example embodiment 2, wherein the instructions, when executed, are to cause the processor to cluster a first set of personas of the one or more personas in a first region, wherein each of the first set of personas consume less than a threshold amount of resources.

EXAMPLE EMBODIMENT 4. The tangible, non-transitory, and computer-readable medium of example embodiment 2, wherein the instructions, when executed, are to cause the processor to divide a first persona of the one or more personas into multiple smaller personas and determine routing between each of the multiple smaller personas.

EXAMPLE EMBODIMENT 5. The tangible, non-transitory, and computer-readable medium of example embodiment 1, wherein the instructions, when executed, are to cause the processor to receive an additional design from a same user or a different user to implement onto the programmable fabric of the integrated circuit device.

EXAMPLE EMBODIMENT 6. The tangible, non-transitory, and computer-readable medium of example embodiment 1, wherein the instructions, when executed, are to cause the processor to determine a second persona associated with the design from the library, determine a first region to be configured by the persona and a second region to be configured by the second persona, and generate a clock signal based on a path between the first region and the second region.

EXAMPLE EMBODIMENT 7. The tangible, non-transitory, and computer-readable medium of example embodiment 6, wherein the instructions, when executed, are to cause the processor to determine a location of the first region based on a function of the persona and a location of a network-on-chip and determine a location of the second region based on a function of the second persona and the location of the network-on-chip.

EXAMPLE EMBODIMENT 8. The tangible, non-transitory, and computer-readable medium of example embodiment 1, wherein the library comprising the plurality of personas is generated prior to compilation of the design.

EXAMPLE EMBODIMENT 9. The tangible, non-transitory, and computer-readable medium of example embodiment 8, wherein the plurality of personas comprises personas by a manufacturer, personas generated by a customer, personas generated by other designers, or a combination thereof. EXAMPLE EMBODIMENT 10. A method, comprising receiving, via processing circuitry, a design to implement on an integrated circuit device, mapping, via the processing circuitry, the design to one or more personas stored in a library, wherein the one or more personas are pre-compiled before compilation of other parts of the design, compiling the other parts of the design, and transmitting, via the processing circuitry, a bit stream comprising an indication of the one or more personas to configure a region of the integrated circuit device.

EXAMPLE EMBODIMENT 11. The method of example embodiment 10, wherein mapping, via the processing circuitry, the design to one or more personas comprises generating a data flow based on the design, determining whether notes of the data flow match the one or more personas in the library, and determining one or more respective regions of the integrated circuit device for implementing the one or more personas; and determining a routing between the one or more personas based on the design.

EXAMPLE EMBODIMENT 12. The method of example embodiment 10, wherein mapping, via the processing circuitry, the design to one or more personas comprises determine the persona consumes more resources than the region supports and dividing the persona into a plurality of smaller personas to be implemented by a plurality of regions of the integrated circuit device.

EXAMPLE EMBODIMENT 13. The method of example embodiment 10, comprising receiving, via the processing circuitry, one or more custom operations in the design and storing, via the processing circuitry, the one or more custom operations as one or more custom personas in the library.

EXAMPLE EMBODIMENT 14. The method of example embodiment 10, comprising receiving, via the processing circuitry, one or more additional designs to implement onto the integrated circuit device and transmitting, via the processing circuitry, an additional indication of one or more additional personas to implement by one or more regions of the integrated circuit device, wherein the one or more regions is different from the region.

EXAMPLE EMBODIMENT 15. An integrated circuit device comprising a memory storing a plurality of personas and a plurality of regions comprising programmable logic circuitry and configured by a respective persona of the plurality of personas to implement a design, wherein the respective persona is compiled at a different time than a remainder of the design.

EXAMPLE EMBODIMENT 16. The integrated circuit device of example embodiment 15, comprising a network-on-chip to transmit data to and from a first region of the plurality of regions to a second of the plurality of regions

EXAMPLE EMBODIMENT 17. The integrated circuit device of example embodiment 15, comprising a clock generator register to generate a clock signal for each of the plurality of regions, wherein the clock signal sets a maximum frequency of the each of the plurality of regions.

EXAMPLE EMBODIMENT 18. The integrated circuit device of example embodiment 15, comprising a first set of regions of the plurality of regions being configured with one persona.

EXAMPLE EMBODIMENT 19. The integrated circuit device of example embodiment 15, comprising a first region of the plurality of regions being configured with multiple personas.

EXAMPLE EMBODIMENT 20. The integrated circuit device of example embodiment 19, wherein each of the plurality of personas are to cause configuration of circuitry to communicatively couple implementations of the multiple personas together.

What is claimed is:

1. A tangible, non-transitory, and computer-readable medium, storing instructions thereon, wherein the instructions, when executed, are to cause a processor to:
receive a design to be implemented onto a programmable fabric of an integrated circuit device;
determine that the design is implementable using a persona from a library comprising a plurality of personas;
compile the design, wherein the plurality of personas are compiled at a different time than the design; and
transmit a bit stream to partially reconfigure the integrated circuit device using the persona, wherein the bit stream comprises data to configure a region of the integrated circuit device.

2. The tangible, non-transitory, and computer-readable medium of claim 1, wherein the instructions, when executed, are to cause the processor to:
decompose the design into a compiler data flow graph comprising one or more graph nodes; and
map the one or more graph nodes to one or more personas of the plurality of personas.

3. The tangible, non-transitory, and computer-readable medium of claim 2, wherein the instructions, when executed, are to cause the processor to cluster a first set of personas of the one or more personas in a first region, wherein each of the first set of personas consume less than a threshold amount of resources.

4. The tangible, non-transitory, and computer-readable medium of claim 2, wherein the instructions, when executed, are to cause the processor to:
divide a first persona of the one or more personas into multiple smaller personas; and
determine routing between each of the multiple smaller personas.

5. The tangible, non-transitory, and computer-readable medium of claim 1, wherein the instructions, when executed, are to cause the processor to receive an additional design from a same user or a different user to implement onto the programmable fabric of the integrated circuit device.

6. The tangible, non-transitory, and computer-readable medium of claim 1, wherein the instructions, when executed, are to cause the processor to:
determine a second persona associated with the design from the library;
determine a first region to be configured by the persona and a second region to be configured by the second persona; and
generate a clock signal based on a path between the first region and the second region.

7. The tangible, non-transitory, and computer-readable medium of claim 6, wherein the instructions, when executed, are to cause the processor to:
determine a location of the first region based on a function of the persona and a location of a network-on-chip; and
determine a location of the second region based on a function of the second persona and the location of the network-on-chip.

8. The tangible, non-transitory, and computer-readable medium of claim 1, wherein the library comprising the plurality of personas is generated prior to compilation of the design.

9. The tangible, non-transitory, and computer-readable medium of claim 8, wherein the plurality of personas comprises personas by a manufacturer, personas generated by a customer, personas generated by other designers, or a combination thereof.

10. A method, comprising:
receiving, via processing circuitry, a design to implement on an integrated circuit device;
mapping, via the processing circuitry, the design to one or more personas stored in a library, wherein the one or more personas are pre-compiled before compilation of other parts of the design;
compiling the other parts of the design; and
transmitting, via the processing circuitry, a bit stream comprising an indication of the one or more personas to configure a region of the integrated circuit device.

11. The method of claim 10, wherein mapping, via the processing circuitry, the design to one or more personas comprises:
generating a data flow based on the design;
determining whether nodes of the data flow match the one or more personas in the library;
determining one or more respective regions of the integrated circuit device for implementing the one or more personas; and determining a routing between the one or more personas based on the design.

12. The method of claim 10, wherein mapping, via the processing circuitry, the design to one or more personas comprises:
generating a data flow comprising a graph node based on the design;
determining the graph node matches a persona of the one or more personas stored in the library;
determine the persona consumes more resources than the region supports; and
dividing the persona into a plurality of smaller personas to be implemented by a plurality of regions of the integrated circuit device.

13. The method of claim 10, comprising:
receiving, via the processing circuitry, one or more custom operations in the design; and
storing, via the processing circuitry, the one or more custom operations as one or more custom personas in the library.

14. The method of claim 10, comprising:
receiving, via the processing circuitry, one or more additional designs to implement onto the integrated circuit device; and
transmitting, via the processing circuitry, an additional indication of one or more additional personas to implement by one or more regions of the integrated circuit device, wherein the one or more regions is different from the region.

15. An integrated circuit device, comprising:
a memory storing a plurality of personas; and
a plurality of regions comprising programmable logic circuitry and configured by a respective persona of the plurality of personas to implement a design, wherein the respective persona is compiled at a different time than a remainder of the design.

16. The integrated circuit device of claim 15, comprising a network-on-chip to transmit data to and from a first region of the plurality of regions to a second of the plurality of regions.

17. The integrated circuit device of claim 15, comprising a clock generator register to generate a clock signal for each of the plurality of regions, wherein the clock signal sets a maximum frequency of the each of the plurality of regions.

18. The integrated circuit device of claim 15, comprising a first set of regions of the plurality of regions being configured with one persona.

19. The integrated circuit device of claim 15, comprising a first region of the plurality of regions being configured with multiple personas.

20. The integrated circuit device of claim 19, wherein each of the plurality of personas are to cause configuration of circuitry to communicatively couple implementations of the multiple personas together.
